(19) United States
(12) Patent Application Publication
(10) Pub. No.: US 2009/0091519 A1
(43) Pub. Date: Apr. 9, 2009

(54) DISPLAY METHOD OF DISPLAY DEVICE AND DISPLAY DEVICE

(75) Inventors: Rei Momose, Kunitachi (JP); Masaya Tajima, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi, Ltd.

(21) Appl. No.: 12/186,022

(22) Filed: Aug. 5, 2008

(30) Foreign Application Priority Data
Oct. 5, 2007 (JP) 2007-262106

(51) Int. Cl. G09G 3/28

(52) U.S. Cl. 345/72

(57) ABSTRACT

Image quality deterioration resulting from a dither process is controlled by using a matrix like random pattern as a dither toggle pattern in signal processing for display such as a plasma display. A matrix like random pattern is generated for each frame in a pseudorandom code generator as a dither toggle pattern, or is reused after reversing bits.

### CROSS-REFERENCE TO RELATED APPLICATION

The present application claims priority from Japanese Patent Application No. JP 2007-262106 filed on Oct. 5, 2007, the content of which is hereby incorporated by reference into this application.

### TECHNICAL FIELD OF THE INVENTION

The present invention relates to a digital display device used as a display terminal and the like of a television set or a computer, and a technology for a display method for the same. More specifically, the present invention relates to a technology for signal processing of display data (digital signal).

### BACKGROUND OF THE INVENTION

As a conventional digital display device, there is a plasma display apparatus (hereinafter referred to as “PDP apparatus”) provided with, for example a plasma display panel (hereinafter referred to as “PDP”), and a display control unit, and a driving circuit unit thereof. In signal processing of display data for displaying with the PDP in the PDP apparatus, a noise may be generated in the display image of PDP because of a combination of a plurality of processes. The combination of the plurality of processes includes, for example, a combination of an error diffusion process and a data conversion process for output with the PDP in the following stage. The noise to be generated includes the noise generated in a specific gradation in an image.

Conventionally, as a measure against the noise, another process, for example, a dither process or the like is applied to the combination of the plurality of processing in order to remove or reduce the noise of the display data and the image. For example, the dither process step is applied before the error diffusion process step. In this process, as dither toggle patterns are well known as a technology to use the dither process and a technology to use a uniformed dither toggle pattern, as well as a technology to change dither toggle patterns at constant period. For example, Japanese Patent Application Laid-Open Publication No. H06-324656 discloses a method for performing the dither process using different dither toggle patterns in odd fields and even fields.

However, when a dither toggle pattern having a checkered pattern with a highest frequency is used continuously, there is generated a rough surface in a zigzag state on a screen.

In addition, when dither toggle patterns are periodically changed as disclosed in the above Japanese Patent Application Laid-Open Publication No. H06-324656, the toggle pattern for frame modulation could interfere with the dither toggle pattern to generate fixed pattern noises such as stripes and hatched lines.

It is an object of the present invention to prevent an image quality deterioration resulting from the dither process by using a matrix shaped random pattern as a dither toggle pattern in signal processing for display such as a plasma display.

### SUMMARY OF THE INVENTION

The above and other objects and novel characteristics of the present invention will be apparent from the description of this specification and the accompanying drawings.

The typical ones of the inventions disclosed in this application will be briefly described as follows.

A digital display device according to a typical embodiment of the present invention is comprised of: a dither toggle pattern generator including: a line counter for counting a horizontal synchronization signal; a dot counter for counting a dot clock after an input of the horizontal synchronization signal; an initial value setter; a pseudorandom code generator for generating a pseudorandom number based on an initial value obtained from the initial value setter; an m-bit register for storing an output of m bits (m: integer) from the pseudorandom code generator; and a selector; a dither synthesis unit; and an error diffusion processor; wherein the initial value setter outputs the initial value to the pseudorandom code generator at an output timing of the line counter, the pseudorandom code generator generates and outputs a pseudorandom code at a timing of the dot clock when an m dot count signal by the dot counter is not outputted, the m-bit register stores the pseudorandom code when the m dot count signal by the dot counter is not outputted, the selector outputs an output of the pseudorandom code generator when the m dot count signal by the dot counter is not outputted, and outputs an output of the m-bit register when the m dot count signal by the dot counter is outputted to the dither synthesis unit as a dither toggle pattern, and a result obtained by a dither synthesis in the dither synthesis unit is outputted to the error diffusion processor.

The effects obtained by typical aspects of the present invention will be briefly described below.

According to the present invention, the image quality deterioration resulting from the dither process can be prevented.

### BRIEF DESCRIPTIONS OF THE DRAWINGS

FIG. 1 is a block diagram showing the structure of the image signal processor of a digital display device;

FIG. 2 is a block diagram showing positioning of the image signal processor in the digital display device;

FIG. 3 is a diagram for describing the operation contemplated in the first embodiment of the present invention;

FIG. 4 is a diagram for describing the operation contemplated in the first embodiment;

FIG. 5 is a block diagram showing the structure of the dither processor;

FIG. 6 is a block diagram of the dither synthesis unit;

FIG. 7 is a block diagram showing the structure of the dither toggle pattern generator in accordance with the first embodiment;

FIG. 8 is a block diagram showing the basic structure of the pseudorandom code generator;

FIG. 9 is a diagram for describing the operation contemplated in the second embodiment of the present invention;

FIG. 10 is a block diagram showing the structure of the dither toggle pattern generator in accordance with the second embodiment;

FIG. 11 is a diagram for describing the operation contemplated in the third embodiment of the present invention;

FIG. 12 is a block diagram showing the structure of the dither toggle pattern generator in accordance with the third embodiment;

FIG. 13 is a diagram for describing the operation contemplated in the fourth embodiment of the present invention;

FIG. 14 is a diagram for describing the operation contemplated in the fifth embodiment of the present invention;

FIG. 15 is a block diagram showing the structure of the dither toggle pattern generator in accordance with the fifth embodiment;

FIG. 16 is a diagram for describing the operation contemplated in the sixth embodiment of the present invention;

FIG. 17 is a block diagram showing the structure of the dither toggle pattern generator in accordance with the sixth embodiment; and

FIG. 18 is a block diagram showing the structure of the dither toggle pattern generator in accordance with the seventh embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

(Basic Technology of Plasma Display Apparatus)

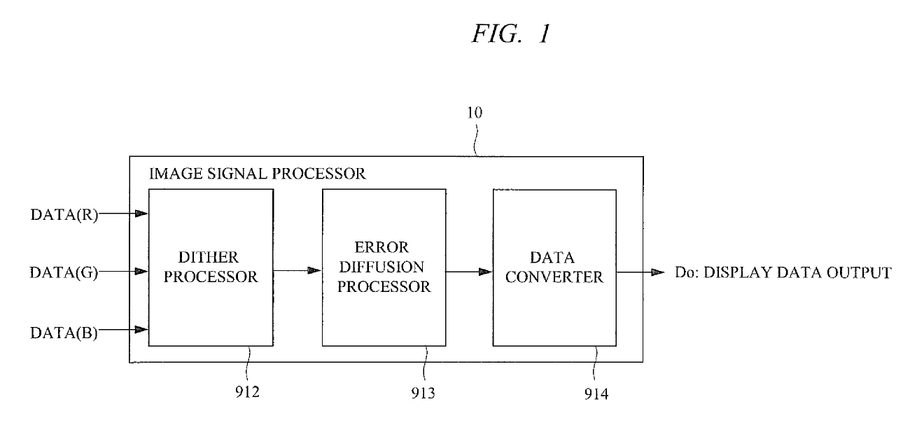

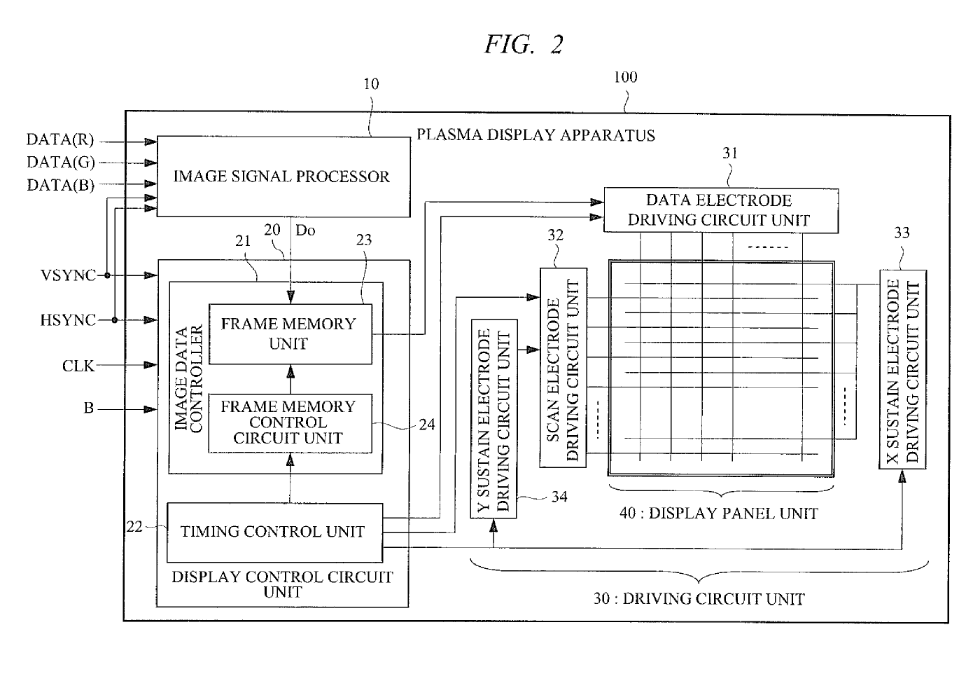

The structure of the plasma display apparatus will be described first. FIG. 2 shows a whole configuration of the plasma display apparatus used as a digital display device. The plasma display apparatus (PDP apparatus) 100 includes a display panel unit (PDP) 40, a driving circuit unit 30, a display control circuit unit 20, and an image signal processor 10 (circuit of FIG. 1), and the like. The driving circuit unit 30 is connected to the display panel unit 40, and the driving circuit unit 30 is connected to the display control circuit unit 20. The image signal processor 10 connected to the display control circuit unit 20 is also included. The image signal processor 10 can be provided in the display control circuit unit 20.

As the hardware configuration of the plasma display apparatus 100, a PDP module is provided, in which, for example, the display panel unit 40 is fixed to a chassis part (not shown), the PDP module is arranged with an IC embedded with each circuit units such as the display control circuit unit 20, and a power circuit unit (not shown), and the like on the back side of the chassis part. The circuit unit on the back side of the chassis part and the end of the display panel unit 40 are connected by a driver module (a module embedded with a driver IC and the like on a flexible base) corresponding to the driving circuit unit 30. The PDP module with such the configuration is housed in an external case to constitute a PDP apparatus set.

The image signal processor 10, as shown in FIG. 1, is inputted display data from outside, performs a display data conversion, the noise reduction processing of the display data, and the like, and outputs the display data “Do” to the image data controller 21. The display data inputted is in the RGB format, for example, and comprises signals of the display data (R), the display data (G), and the display data (B) corresponding to the respective colors R (red), G (green), and B (blue). The display data (inputted digital signal) is first inputted into a dither processor 912 and the dither process is performed. An output thereof is next inputted into an error diffusion processor 913 and an error diffusion process is performed. After the error diffusion process, the output is sent to a data converter 914 to perform a data conversion to output to the display panel, and is outputted as the display data “Do”. The image signal processor 10 is embedded, for example, with hardware such as ASIC (Application-Specific Integrated Circuit).

The display control circuit unit 20 has the image data control unit 21 and a timing control unit 22. The display control circuit unit 20 generates a control signal for controlling the driving circuit unit 30 based on an interface signal {CLK (dot clock), B (blanking signal), VSYNC (vertical synchronization), HSYNC (horizontal synchronization)} inputted from outside, and controls the driving circuit unit 30 therewith. The data electrode driving circuit unit 31 is controlled from the image data controller 21 based on the display data “Do” accumulated in a frame memory unit 23. A timing signal from the timing control unit 22 controls the data electrode driving circuit unit 31, a scan electrode driving circuit unit 32, and X and Y sustain electrode driving circuit units 33 and 34, respectively.

The image data controller 21 has the frame memory unit 23 and the frame memory control circuit unit 24. The image data controller 21 controls supply of the display data to the driving circuit unit 30. The timing control unit 22 generates a timing signal to control the timing for the display process, and supplies the signal to the frame memory control circuit unit 24, the data electrode driving circuit unit 31, the scan electrode driving circuit unit 32, the X sustain electrode driving circuit unit 33, and the Y sustain electrode driving circuit unit 34. The frame memory unit 23 stores the display data “Do” from the image signal processor 10. The frame memory control circuit unit 24 controls the frame memory unit 23 according to the timing signal, and outputs the display data from the frame memory unit 23 to the data electrode driving circuit unit 31.

The driving circuit unit 30 has the data (address) electrode driving circuit unit 31, the scan electrode driving circuit unit 32, the X sustain electrode driving circuit unit 33, and the Y sustain electrode driving circuit unit 34. The driving circuit unit 30 drives the electrode of PDP 40 according to the control signal from the display control circuit unit 20. The data electrode driving circuit unit 31 drives a data line (address electrode) of the PDP 40 based on the display data from the frame memory unit 23. The scan electrode driving circuit unit 32 drives a scanning line (which corresponds to a Y electrode) of the PDP 40. The X sustain electrode driving circuit unit 33 drives an X electrode of the PDP 40. The Y sustain electrode driving circuit unit 34 drives the Y electrode of the PDP 40 via the scan electrode driving circuit unit 32. In the display screen of the PDP 40, the data electrode driving circuit unit 31 and the scan electrode driving circuit unit 32 are driven to perform address discharge for determining a display cell. Subsequently, the X and Y sustain electrode driving circuit units 33 and 34 are driven to perform sustaining discharge for making the display cell emit light.

Hereafter, embodiments of the present invention will be described based on the basic structure of the plasma display apparatus described above.

### First Embodiment

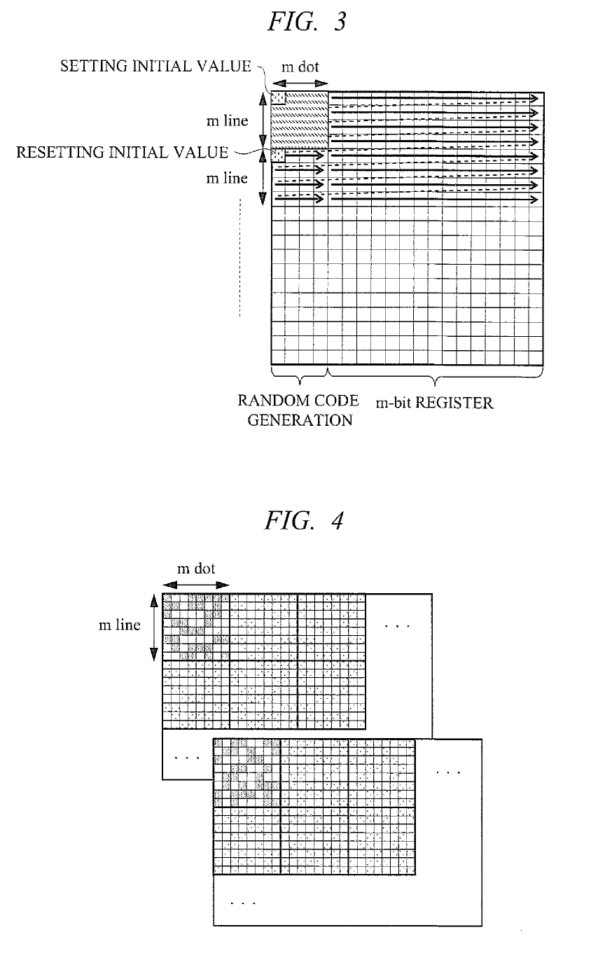

FIGS. 3 and 4 are diagrams for describing the operation contemplated in the first embodiment of the present invention.

In this embodiment, a matrix shaped toggle pattern (matrix pattern) of having m lines and m columns is generated, and is memorized in a memory. The “m” herein is an arbitrary integral value. In this process, since an actual dither toggle pattern is outputted by row, the pattern may be stored in the memory during the output period of one line. The hatched part without an arrow in FIG. 3 is the matrix shaped toggle pattern to be generated.

In this embodiment, a “predetermined initial value” of a pseudorandom number used for generating the toggle pattern is supplied when generating a toggle at the upper left of the frame, which is the beginning or head of the image data displayed on the frame. After the supply, a clock is supplied to a pseudorandom number generator to generate the pseudorandom number for m bits. While the operation clock is supplied, the pseudorandom number generator continues to output the pseudorandom numbers, stores the numbers in a predetermined storage unit, and outputs as the first m bit information for the dither toggle patterns.

After the clock is supplied m times, the remaining bits in one line in the dither toggle pattern (the number of horizontal dots on the screen) are outputted from the information stored in the storage unit.

When the output for one line is finished, the clock is again supplied to the pseudorandom number generator. At this time, setting of the initial value is not performed and generation of the pseudorandom number is continued. When the clock is supplied to the pseudorandom number generator m times, the remaining bits for one line in the dither toggle pattern (the number of horizontal dots on the screen) are outputted from the information stored in the storage unit. The above-mentioned process is repeatedly continued for m lines from the pixel at the upper left of the frame. After that, at the m+1 line, the “predetermined initial value” set at the upper left end of the frame is again supplied to generate a pseudorandom number. Repeating this process generates a dither toggle pattern for one frame covered with toggle patterns of m×m in frames.

The capacity of the storage unit needed for performing this process is m bits instead of m×m bit. That is, it is necessary to store only m bits for one line.

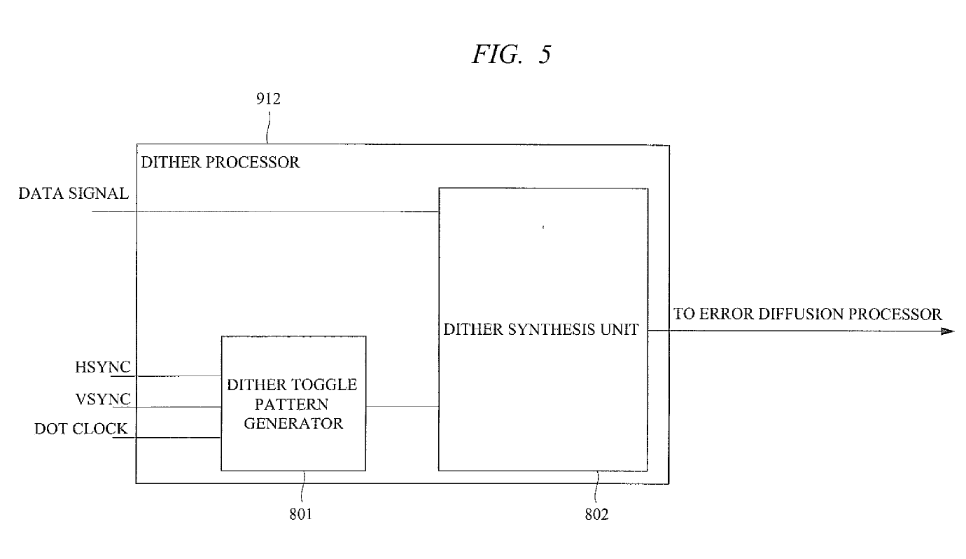

FIG. 5 is a block diagram showing the structure of the dither processor 912 in this embodiment. This dither processor 912 comprises a dither toggle pattern generator 801 and a dither synthesis unit 802.

The dither toggle pattern generator 801 is a circuit for generating the matrix pattern for each frame. A vertical synchronization signal (VSYNC) signal is inputted into the dither toggle pattern generator 801 and functions as a trigger of an operation. The output of the dither toggle pattern generator 801 is inputted into the dither synthesis unit 802.

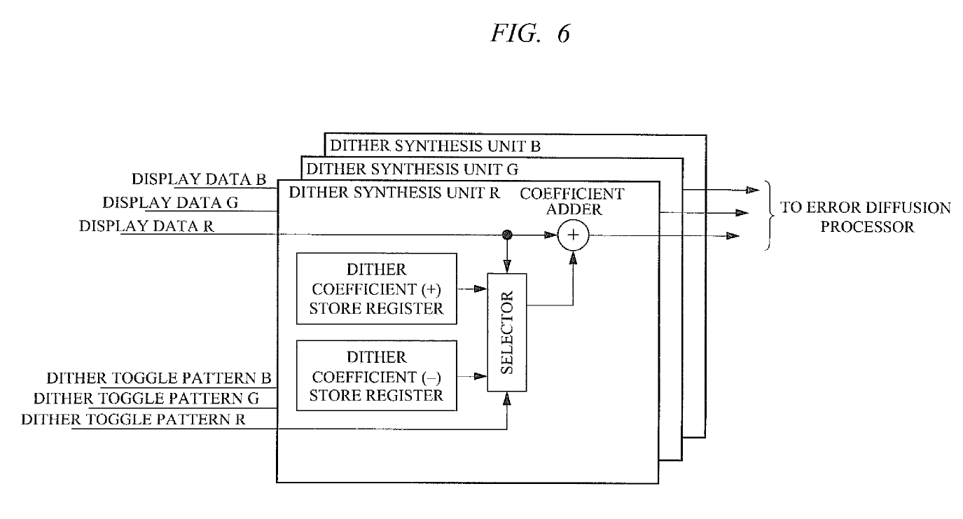

FIG. 6 is a block diagram of the dither synthesis unit 802. A data signal inputted into the image signal processor 10 and an output signal of the dither toggle pattern generator 801 are inputted into the dither synthesis unit 802. The dither synthesis unit 802 generates an output data for the error diffusion processor 913 by logically synthesizing (dither synthesis) the output of the dither toggle pattern generator and the data signal.

The dither toggle pattern outputted from the dither toggle pattern generator 801 is sent out to a selector 701 of the dither synthesis unit. A dither coefficient (+) store register 702 and a dither coefficient (−) store register 703 are connected to the selector 701. In addition, the display data is also inputted into the selector 701. The dither coefficient (+ or −) for performing addition or subtraction to the display data is selected according to the setting of the registers and the gradation level of the inputted display data. The dither toggle pattern is sent out to the coefficient adder 704 along with the judgment of the addition or subtraction to perform a logical operation, and then, is sent out to the error diffusion processor 913.

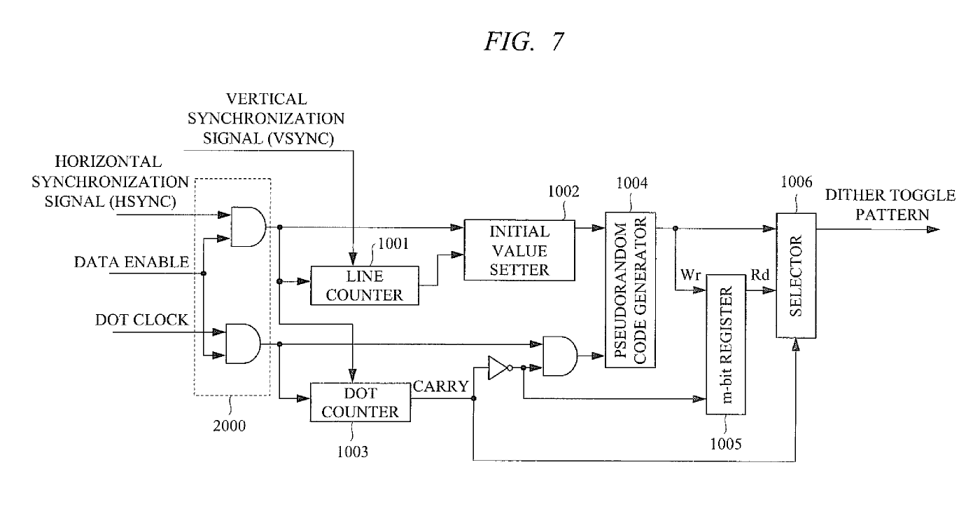

Next, the structure of the dither toggle pattern generator 801 will be described with reference to FIG. 7. The dither toggle pattern generator in accordance with this embodiment comprises a line counter 1001, an initial value setter 1002, a dot counter 1003, a pseudorandom code generator 1004, an m-bit register 1005, and a selector 1006. The dither toggle pattern generator also has an input signal processing unit 2000 for processing an input signal.

The line counter 1001 is a counter to repeatedly count m lines (from 0 to m−1). The vertical synchronization signal is inputted into the line counter 1001 for easy identification of the beginning or head of the frame. For this purpose, the vertical synchronization signal is used for resetting the line counter 1001.

On the other hand, the dot counter 1003 is a counter to count m dots after a horizontal synchronization signal (from 0 to m−1) and stop. The horizontal synchronization signal (HSYNC) is inputted into the dot counter 1003, and thereby, the beginning or head of the dots in the horizontal direction can be checked easily. Therefore, reset of the dot counter 1003 is performed using the horizontal synchronization signal (HSYNC) that is transmitted through the input signal processing unit 2000.

The dot counter 1003 counts that m bits of the dot clock is inputted after resetting the horizontal synchronization signal, and activates a carry signal after inputting m bits. The carry signal is reversed with an inverter to perform an AND operation with the dot clock in order to suspend the supply of the clock to the pseudorandom code generator 1004. In addition, as the carry signal becomes active, the selector 1006 outputs a value of the m-bit register 1005 as a dither toggle pattern. Furthermore, the reversed carry signal is inputted into the m-bit register to generate timing for storing the pseudorandom number generated by the pseudorandom code generator 1004.

The carry signal of the dot counter 1003 becomes inactive with a reset, and enters a state to be able to count up again. And the dot counter 1003 counts that m bits of the dot clock is inputted. During this process, the pseudorandom code generator 1004 functions to simultaneously store the pseudorandom number generated by the pseudorandom code generator 1004 in the m-bit register 1005.

The selector 1006 outputs the output of the pseudorandom code generator 1004 to the dither synthesis unit 802. The initial value setter 1002 is a unit to determine the initial value of the dither toggle pattern to be generated. The dither toggle pattern must have a fixed contrast in the dither toggle pattern to achieve a purpose thereof, but the initial value supplied to the pseudorandom code generator 1004 is a matter of design. However, it is necessary to set the same initial value for the pseudorandom code generator 1004 (refer to FIG. 3) according to the reset timing of the initial value that occurs several times in one frame.

The pseudorandom code generator 1004 is a generator of the pseudorandom number, which generates a matrix shaped toggle pattern having m lines and m columns. The pseudorandom number of m bits generated in the pseudorandom code generator 1004 is transmitted to the m-bit register 1005 and the selector 1006. The m-bit register 1005 is a memory for storing the toggle pattern for one line (m bits) outputted from the pseudorandom code generator 1004.

The selector 1006 is a circuit for determining whether to use the output of the pseudorandom code generator 1004 or the output of the m-bit register 1005 as an output of the dither toggle pattern generator. In this process, the output signal is determined by referring to the output (carry) of the dot counter 1003.

Generally, a digital video signal includes the horizontal synchronization signal and the dot clock in the area that is not the image display region. Therefore, if these input signals were not processed in a preceding step, it is impossible to match the dither toggle pattern with the intended display data. The input signal processing unit 2000 is a circuit to eliminate this invalid horizontal synchronization signal. The input signal processing unit 2000 is provided with a data enable signal in addition to the horizontal synchronization signal (HSYNC) and the dot clock.

The horizontal synchronization signal (HSYNC) is a signal indicating the beginning or head of a line. As mentioned above, this signal is not a signal indicating the beginning or head of a drawing area. The dot clock is an operation clock for identifying data of each bit belonging to a line. This also does not guarantee that a bit or an operation clock belongs to the drawing area as same as the horizontal synchronization signal (HSYNC).

The data enable signal is a signal for distinguishing whether the horizontal synchronization signal (HSYNC) and the dot clock being inputted belong to the drawing area. When the data enable signal is active, the horizontal synchronization signal (HSYNC) and the dot clock are inputted into the line counter 1001 or the dot counter 1003, and the dither synthesis unit will be operated.

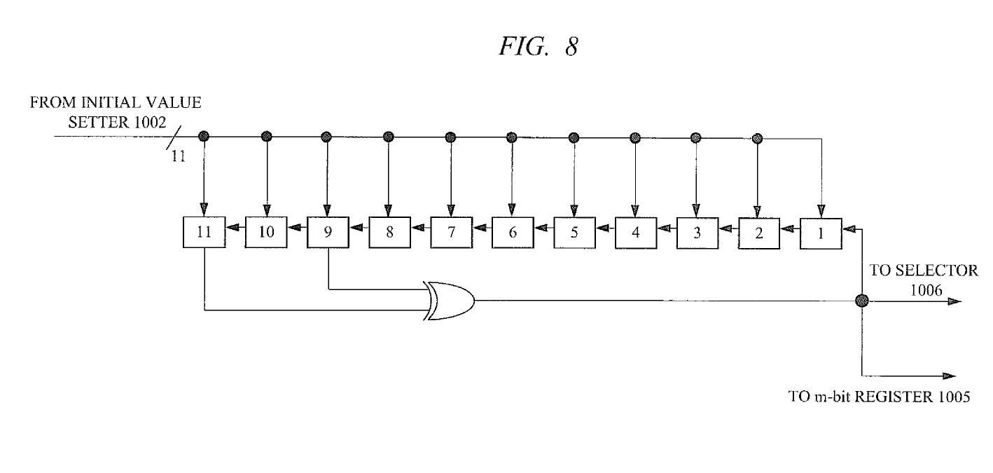

Next, the structure of the pseudorandom code generator 1004 of the dither toggle pattern generator will be described with reference to FIG. 8.

FIG. 8 is a block diagram showing the pseudorandom number generator (PRBS11) that can be applied to the dither toggle pattern generator in accordance with this embodiment. In this circuit, 11 shift registers are connected in series and shifted by 1 bit to a higher order bit in one clock. At this time, logical calculus of the 11 bit and the 9 bit are performed, and the obtained result is set to the 1 bit and, at the same time, is outputted to the pseudorandom code generator 1004 and the selector 1006. Operation timing to be used is a result of the AND operation of the dot clock and a reversed output of the carry signal.

The circuit called PRBS11 with an 11 bit register is shown for convenience herein. However, as long as enough length of a cycle can be guaranteed, the pseudorandom code generator 1004 can include any number of bits.

The above mentioned circuit configuration generates pseudorandom data of m bits in one line between m bits and the input of the horizontal synchronization signal, and the data is recorded in the m-bit register 1005. On the other hand, from m+1 bit to the next input of the horizontal synchronization signal, pseudorandom data recorded in the m-bit register 1005 is repeatedly outputted to generate the dither toggle pattern for one line in one frame.

The dither toggle pattern for m lines is generated by repeating this process for m lines from the first input of the horizontal synchronization signal (processed by the input signal processing unit 2000).

At the m+1 horizontal synchronization signal, the initial value is set for the pseudorandom code generator 1004 again from the initial value setter 1002. At this time, the initial value to be set is the same value as the initial value set for the top line.

Henceforth, the dither toggle pattern for one frame corresponding to all the bits in the frames is generated, and is outputted to the dither synthesis unit. After generating and outputting the dither toggle pattern for one frame, the m-bit register 1005 is reset or changed to a state in which overwriting is possible in order to prepare for the next frame.

The above-mentioned structure generates the dither toggle pattern having random nature in each frame. Thereby, it is possible to provide an image that is suitable for a natural image and has little noise that stands out.

### Second Embodiment

Next, the second embodiment of the present invention will be described.

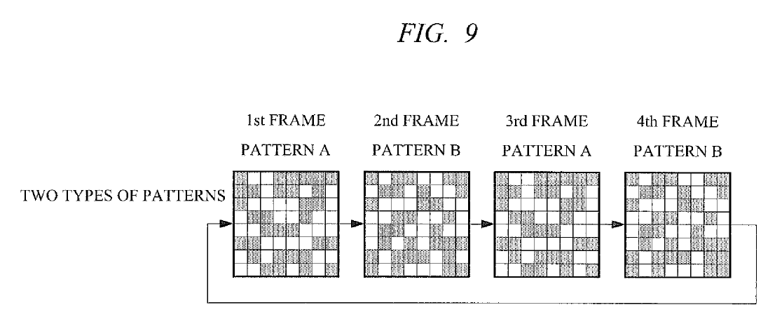

FIG. 9 is a diagram showing the operation contemplated in the second embodiment of the present invention. In this embodiment, one cycle consists of four frames. Also in this embodiment, two types of dither toggle patterns are generated at different timing. That is, when a horizontal synchronization signal is inputted at the beginning of the first frame, creation of a matrix pattern A of m×m dots is started. In the same manner as the first embodiment, when the generation of the dither toggle pattern for the first frame is finished, creation of a matrix pattern B for the following second frame is started, and at the same time, the matrix pattern of m×m dots for the second frames is generated. In this process, in the first embodiment, the matrix pattern of m×m dots for the first frame could be reset or overwritten. In this embodiment, the matrix pattern A for the first frame and the matrix pattern B for the second frame are switched by frame.

Then, for the third frame, the same matrix pattern as the matrix pattern A for the first frame is used. For the third frame, the same matrix pattern and the dither toggle pattern for one frame are generated by supplying the same initial value as the initial value of the first frame to a pseudorandom code generator 1004. For the fourth frame, in the same manner as the third frame, the same matrix pattern and the dither toggle pattern for one frame are generated by supplying the same initial value as the initial value of the second frame to the pseudorandom code generator 1004. The fourth frame is the end of a loop or one cycle and a frame counter 1007 and an initial value setter 1008 are initialized to repeat the above-mentioned procedure from the following or next frame.

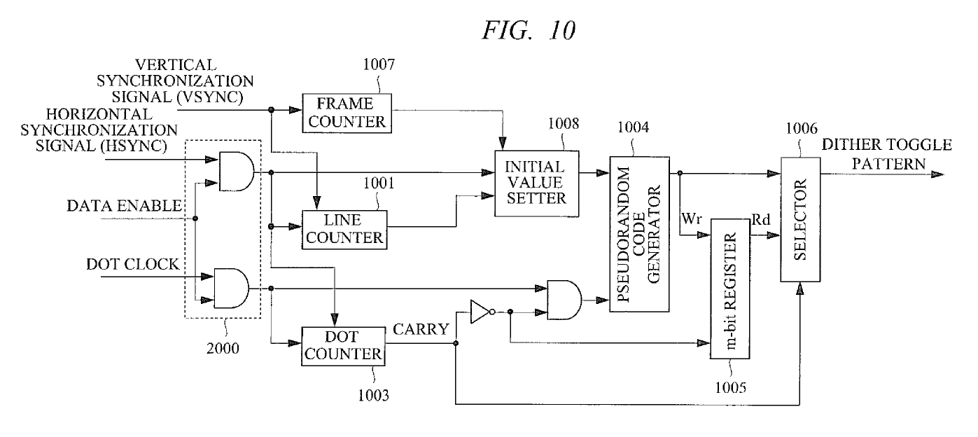

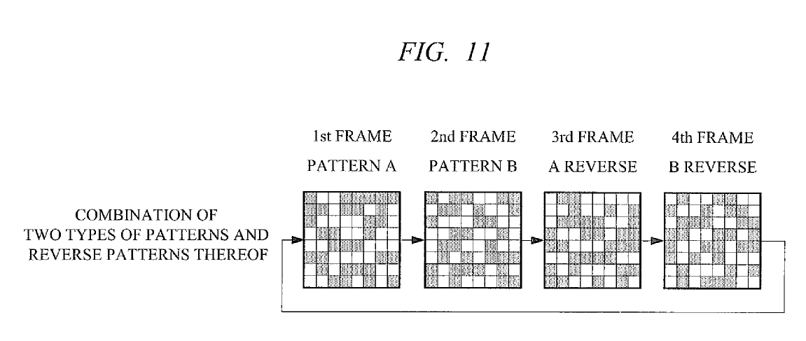

FIG. 10 is a block diagram of the dither toggle pattern generator in accordance with the second embodiment of the present invention. The difference between the first embodiment and the present embodiment is existence or not of the frame counter 1007. In addition, an output of the frame counter 1007 is inputted into the initial value setter 1008, and therefore, the structure thereof is different from the first embodiment.

The frame counter 1007 is a counter for checking or confirming to which one of the first frame to the fourth frame a frame being processed corresponds. The vertical synchronization signal (VSYNC) also inputted in the first embodiment is inputted into this counter. An output of the frame counter 1007 is inputted into the initial value setter 1008, and is reflected on setting of the initial value.

The initial value setter 1008 basically has the same function as the initial value setter 1002 of the first embodiment, but since the same initial values are used for the first frame and the third frame, and the second frame and the fourth frame, a memory for storing these initial values is included.

### Third Embodiment

Next, the third embodiment of the present invention will be described.

FIG. 11 is a diagram showing the operation contemplated in the third embodiment of the present invention. This embodiment is the same with the second embodiment in that one cycle consists of four frames. In the second embodiment, the same matrix patterns and the dither toggle patterns are used for the first frame and the third frame, and the second frame and the fourth frame. As opposed to this, the third embodiment is different in that the matrix pattern for the third frame and the matrix pattern for the fourth frame are reverse patterns of the matrix pattern of the first frame and the matrix pattern of the second frame, respectively. Thereby, since the “displacement” of the patterns between the first frame and the third frame, and between the second frame and the fourth frame is 0, generation of light and shade and the like on a screen due to the matrix pattern can be prevented.

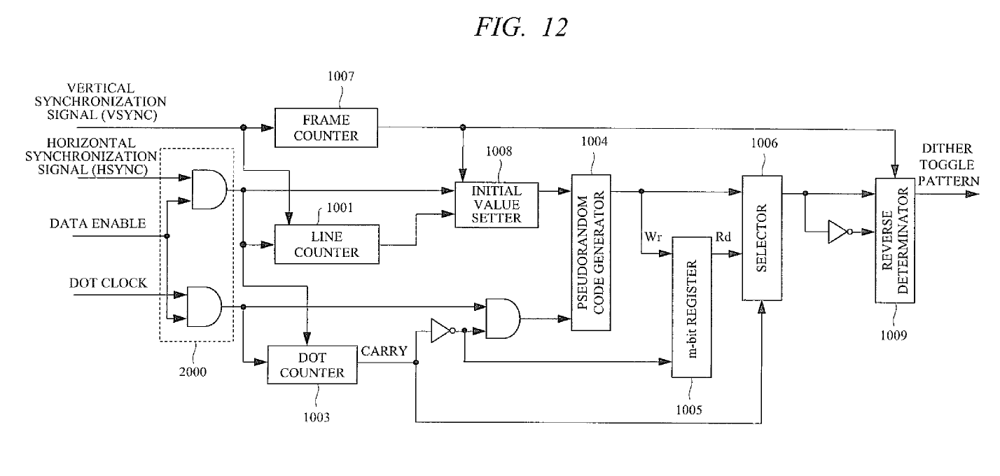

FIG. 12 is a block diagram of a dither toggle pattern generator in accordance with the third embodiment of the present invention. The dither toggle pattern generator is characteristically provided with an inverter at an output of a selector, and a reverse determinator 1009 switches an output according an output of a frame counter 1007.

The reverse determinator 1009 is a switch for switching according to the output of the frame counter 1007. That is, in the above-mentioned example, for the first frame and the second frame, data is inputted without passing through the inverter before being outputted to a dither synthesis unit. For the third frame and the fourth frame, reversed random patterns that went through the inverter is outputted to the dither synthesis unit.

### Fourth Embodiment

Next, the fourth embodiment of the present invention will be described.

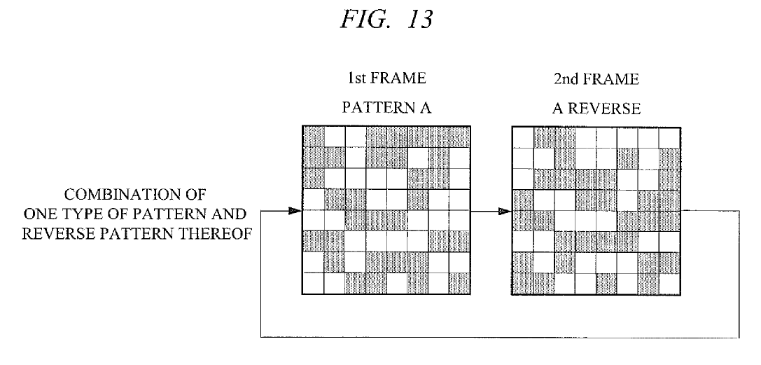

FIG. 13 is a schematic diagram describing the operation contemplated in the fourth embodiment of the present invention. That is, in the fourth embodiment, the third embodiment is simplified, and one cycle consists of 2 frames. A matrix pattern of a first frame is reversed to be used for a second frame.

The circuit configuration of the third embodiment can be used in the same manner, but, since the same initial value is used for the first frame and the second frame, an output of a frame counter 1007 does not have to be inputted into an initial value setter 1008. In addition, the number of counts needed for the frame counter 1007 is “2” (1 bit) instead of “4” (2 bits) described in the third embodiment. Therefore, the whole circuit configuration can be characteristically simplified compared to the third embodiment.

### Fifth Embodiment

The fifth embodiment of the present invention will be described hereinafter.

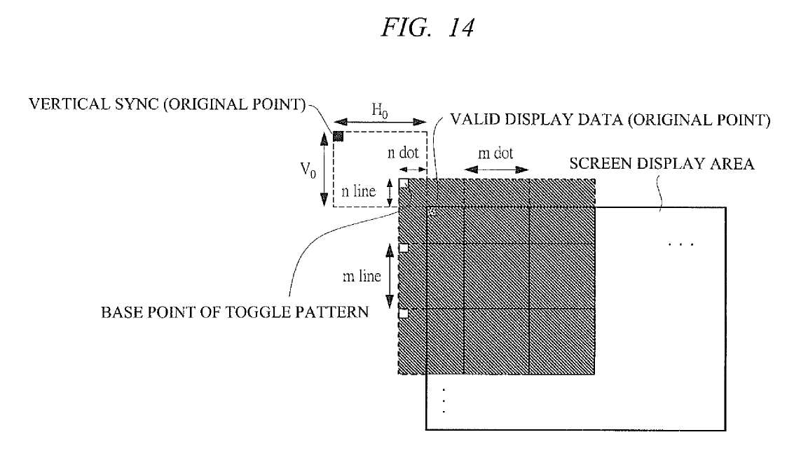

FIG. 14 is a diagram showing differences between this embodiment and the first embodiment. In the embodiments described before, a valid drawing area is guaranteed by a data enable signal, and a line counter value is used to set an initial value of a dither pattern by each m lines. As opposed to this, as shown in FIG. 14, in the fifth embodiment, a screen display area and an area to arrange the dither pattern are characteristically shifted. That is, the dither pattern is arranged from a position n dot away from the left end of the screen. That is, not only guarantee for the drawing area by the data enable signal is intentionally ignored, but also the dither toggle pattern is intentionally shifted in the horizontal direction and in the vertical direction by n dots (n: variable) so that one dither toggle pattern can be used in a plurality of ways. This is performed, as described in the first embodiment, by using the horizontal synchronization signal and the dot clock operating outside the drawing area.

The dot from the input location of a vertical synchronization signal (HSYNC) to the dot of a valid display is defined as V₀. The number of clocks from the horizontal synchronization signal (VSYNC) to the valid display is defined as H₀. Therefore, the original point of the valid drawing area is in a position shifted by V₀ lines and H₀ dots from the input location of the vertical synchronization signal (HSYNC). In this embodiment, the point shifted by n lines and n dots from the original point of the valid drawing area is defined as a base point of the toggle pattern of m lines and m columns. And the toggle pattern of m lines and m columns is generated from this point.

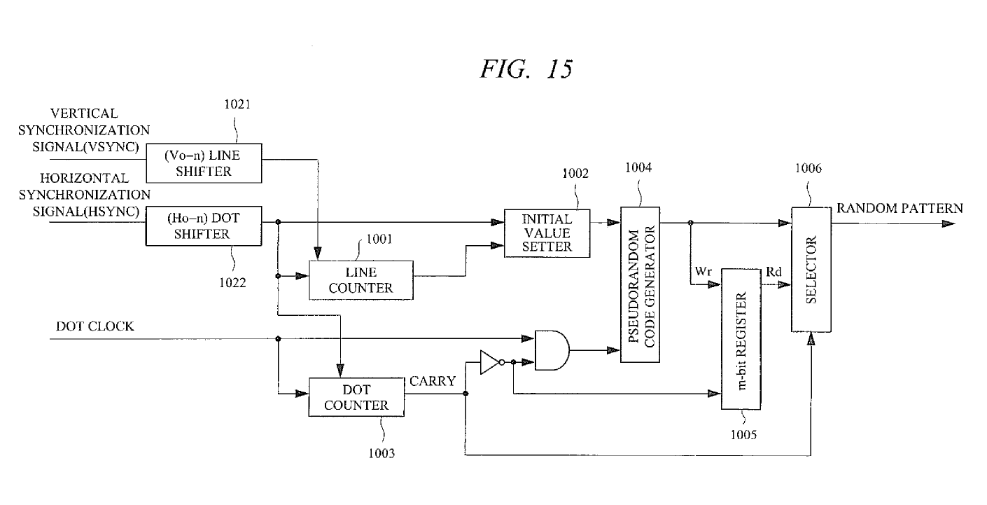

FIG. 15 is a block diagram of a dither toggle pattern generator in accordance with the fifth embodiment of the present invention. Although the basic structure is the same as that of the first embodiment, as mentioned above, in this embodiment, since the valid drawing area is not guaranteed by the data enable signal, an input signal processing unit 2000 that exists in and before the fourth embodiment does not exist. Instead, a (V₀−n) line shifter 1021 and a (H₀−n) dot sifter 1022 exist.

The (V₀−n) line shifter 1021 generates an output with a delay of (V₀−n) lines from the vertical synchronization signal. The output is used as a reset signal for a line counter 1001. The (H₀−n) dot sifter 1022 generates an output with a delay of (H₀−n) dots from the horizontal synchronization signal. This output is used as an increasing timing signal of the line counter 1001, and a reset signal of a dot counter 1003.

By the above configuration, the line counter 1001 is located or operated n lines ahead of the upper end or top end of the valid drawing area. The dot counter 1003 starts operation in a position of n dots ahead of the left end of the valid drawing area. Thereby, the dither toggle pattern can be “shifted”.

### Sixth Embodiment

The sixth embodiment of the present invention will be described hereinafter.

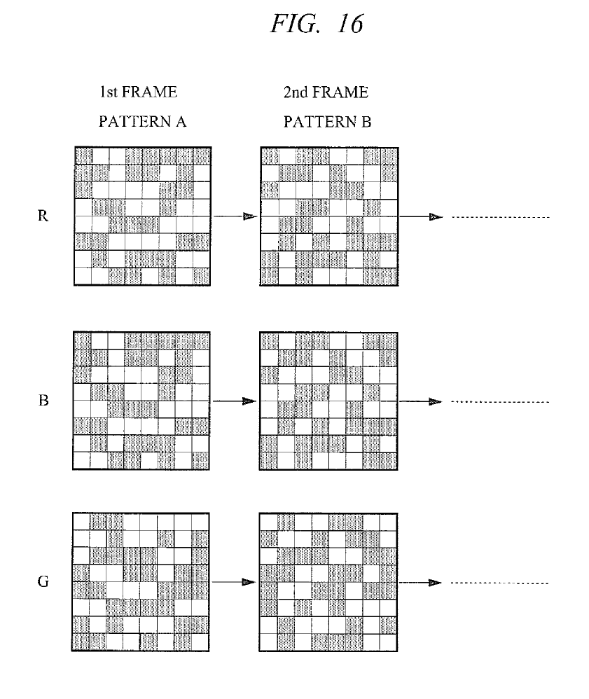

FIG. 16 is a schematic diagram describing the operation contemplated in this embodiment. In the preceding embodiments, the same dither toggle pattern is used for three colors including red (R), green (G), and blue (B) constituting the display color of the screen. As opposed to this, in the sixth embodiment, a toggle pattern of only green (G) is reversed against other two colors among the three colors to prevent a feeling of a rough surface because of the influence of a dither toggle pattern on the whole screen. Only green (G) is reversed because the brightness of RGB constituting each dot is 3:6:1 respectively, and the brightness can be balanced when green (G) is reversed.

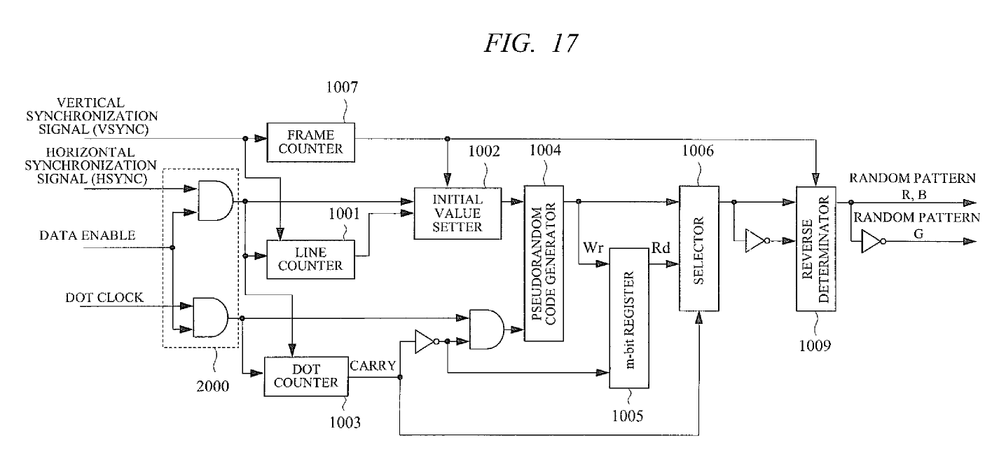

FIG. 17 is a block diagram of a dither toggle pattern generator in accordance with this embodiment. In this block diagram, elements related to this embodiment are added to the block diagram of FIG. 12 in accordance with the third embodiment. However, the dither toggle pattern generator can be applied to any one of the first embodiment to the fifth embodiment. As understood by FIG. 17, only an output of green (G) from a reverse determinator 1009 is reversed and outputted. Thereby, variation in the brightness is uniformed, and a moire like pattern that is not intended to be outputted can be prevented from being displayed on the screen.

### Seventh Embodiment

The seventh embodiment of the present invention will be described hereinafter. In the seventh embodiment, one color is reversed against the other two colors among the three colors including red (R), green (G), and blue (B). As opposed to this, in the seventh embodiment, a random pattern is outputted for each color.

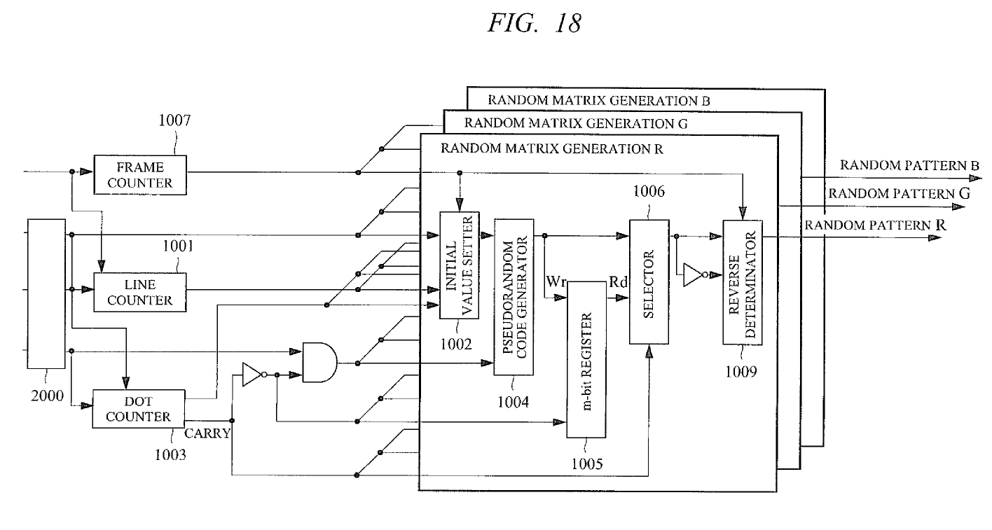

FIG. 18 is a block diagram showing the structure of a dither toggle pattern generator in accordance with the seventh embodiment. In the dither toggle pattern generator, a line counter, a dot counter, and a frame counter that generate a control signal are shared by the three colors. And circuits for generating a pseudorandom code after an initial value setter are provided for each color. This configuration allows generation of a different dither toggle pattern for each of the three colors so that not only the brightness difference of light and darkness, but also deviation of the brightness in red (R), green (G), and blue (B) can be more effectively dispersed.

The invention devised by the inventor has been specifically described in accordance with the embodiments, but the present invention is not limited to the above-mentioned embodiments, and can be variously modified without departing the technical scope thereof.

(Additional Description)

The digital display device in accordance with the present invention can be characterized in that the dither toggle pattern is changed at random by frame in order to eliminate interference with a toggle pattern of a frame modulation.

In addition, the digital display device can be characterized in that the line counter repeats counting m times while the horizontal synchronization signal is inputted, and outputs the timing signal to the initial value setter every m counts.

In addition, the digital display device can be characterized in that the dot counter stops counting by receiving the dot clock m times, and outputs an m dot count signal.

The digital display device can be characterized in that the initial value setter outputs the same initial value to the pseudorandom code generator every m lines in the same frame.

The digital display device can be characterized in that the initial value setter changes the initial values for each frame, and also in that the initial value setter changes the initial values for odd frames and even frames.

The digital display device can be characterized in that the reverse determinator is further included, an output of the selector is branched and reversed, and the reverse determinator outputs either one of the output or the reversed output of the selector as a dither toggle pattern.

The digital display device can be characterized in that the line counter is reset by the vertical synchronization signal.

The digital display device can be characterized in that the (V₀−n) line shifter which delays the vertical synchronization signal is further included, and in that the (H₀−n) dot sifter which delays the horizontal synchronization signal is further included.

The digital display device can be characterized in that the line counter counts the display line, and the dot counter counts the display dot.

These digital display devices can be characterized in that the dither toggle pattern generator generates the dither toggle pattern of each drawing data of three colors including red, blue, and green, and the dither toggle pattern of the drawing data of green is a reversed dither toggle pattern of the drawing data of red. In addition, these digital display devices can be characterized in that the dither toggle pattern of the drawing data of green is a reversed dither toggle pattern of the drawing data of blue.

The digital display device in accordance with a typical embodiment of the present invention can be characterized in that the digital display device includes a dither toggle pattern generator comprising: a line counter for counting the horizontal synchronization signal; a dot counter for counting the dot clock after the input of the horizontal synchronization signal; an error diffusion processor; an initial value setter; a pseudorandom code generator for generating a pseudorandom number based on an initial value obtained from the initial value setter; an m-bit register for storing an output of m bits (m: integer) from the pseudorandom code generator; and a selector, the number of the dither toggle pattern generators being the same as that of the color data to be handled, wherein the initial value setter of each of the dither toggle pattern generators outputs the initial value to the pseudorandom code generator in the same dither toggle pattern generator at the output timing of the line counter, the pseudorandom code generator of each of the dither toggle pattern generators generates and outputs a pseudorandom code in the same dither toggle pattern generator at the timing of the dot clock when the m dot count signal by the dot counter is not outputted, the m-bit register of each of the dither toggle pattern generators stores the pseudorandom code in the same dither toggle pattern generator when the m dot count signal by the dot counter is not outputted, the selector of each of the dither toggle pattern generators outputs an output of the pseudorandom code generator when the m dot count signal by dot counter is not outputted, and outputs an output of the m-bit register when the m dot count signal by the dot counter is outputted to the dither synthesis unit as a dither toggle pattern, and the result obtained by the dither synthesis using the output from the selector inputted into the dither synthesis unit is outputted to the error diffusion processor.

The dither toggle pattern of digital display devices, such as a liquid crystal or a plasma display is provided and contemplated, but is not limited to use therein. For example, the present invention can also be applied to the next-generation digital display devices, such as an organic Electro-Luminescence and an SED (Surface-conduction Electron-emitter Display).

What is claimed is:

1. A digital display device including:
a dither toggle pattern generator comprising:
a line counter for counting a horizontal synchronization signal;
a dot counter for counting a dot clock after an input of the horizontal synchronization signal;
an initial value setter;
a pseudorandom code generator for generating a pseudorandom number based on an initial value obtained from the initial value setter;
an m-bit register for storing an output of m bits (m: integer) from the pseudorandom code generator; and
a selector;
a dither synthesis unit; and
an error diffusion processor; wherein
the initial value setter outputs the initial value to the pseudorandom code generator at an output timing of the line counter,
the pseudorandom code generator generates and outputs a pseudorandom code at a timing of the dot clock when an m dot count signal by the dot counter is not outputted,
the m-bit register stores the pseudorandom code when the m dot count signal by the dot counter is not outputted,
the selector outputs an output of the pseudorandom code generator when the m dot count signal by the dot counter is not outputted, and outputs an output of the m-bit register when the m dot count signal by the dot counter is outputted to the dither synthesis unit as a dither toggle pattern, and
a result obtained by a dither synthesis in the dither synthesis unit is outputted to the error diffusion processor.

2. The digital display device according to claim 1, wherein
the dither toggle pattern is changed at random by frame in order to eliminate interference with a toggle pattern of a frame modulation.

3. The digital display device according to claim 1, wherein
the line counter repeats counting m times while the horizontal synchronization signal is inputted, and outputs a timing signal to the initial value setter every m counts.

4. The digital display device according to claim 1, wherein
the dot counter stops counting by receiving input of the dot clock m times, and outputs the m dot count signal.

5. The digital display device according to claim 1, wherein
the initial value setter outputs the same initial value to the pseudorandom code generator every m lines in the same frame.

6. The digital display device according to claim 1, wherein
the initial value setter changes the initial values for each frame.

7. The digital display device according to claim 1, wherein
the initial value setter changes the initial values for odd frames and even frames.

8. The digital display device according to claim 1, wherein
a reverse determinator is further included, an output of the selector is branched and reversed, and the reverse determinator outputs either one of the output or the reversed output of the selector as the dither toggle pattern.

9. The digital display device according to claim 1, wherein
the line counter is reset by a vertical synchronization signal.

10. The digital display device according to claim 9,
further comprising a (V₀−n) line shifter for delaying the vertical synchronization signal.

11. The digital display device according to claim 9,
further comprising a (H₀−n) dot sifter for delaying the horizontal synchronization signal.

12. The digital display device according to claim 1, wherein
the line counter counts a display line and the dot counter counts a display dot.

13. The digital display device according to claim 1, wherein
the dither toggle pattern generator generates each color of the dither toggle pattern with respect to each drawing data of three colors including red, blue, and green, and the dither toggle pattern of the drawing data of green is a reversed dither toggle pattern of the drawing data of red.

14. The digital display device according to claim 1, wherein
the dither toggle pattern generator generates the dither toggle pattern of each drawing data of three colors including red, blue, and green, and the dither toggle pattern of the drawing data of green is a reversed dither toggle pattern of the drawing data of blue.

15. A digital display device including a dither toggle pattern generator:
the number of the dither toggle pattern generators being the same as that of color data to be handled, wherein
the dither toggle pattern generator comprising:
a line counter for counting a horizontal synchronization signal;
a dot counter for counting a dot clock after an input of the horizontal synchronization signal;
an error diffusion processor;
an initial value setter;
a pseudorandom code generator for generating a pseudorandom number based on an initial value obtained from the initial value setter;
an m-bit register for storing an output of m bits (m: integer) from the pseudorandom code generator; and
a selector; and wherein
the initial value setter of each of the dither toggle pattern generators outputs the initial value to the pseudorandom code generator in the same dither toggle pattern generator at an output timing of the line counter,
the pseudorandom code generator of each of the dither toggle pattern generators generates and outputs a pseudorandom code in the same dither toggle pattern generator at a timing of the dot clock when an m dot count signal by the dot counter is not outputted,
the m-bit register of each of the dither toggle pattern generators stores the pseudorandom code in the same dither toggle pattern generator when the m dot count signal by the dot counter is not outputted,
the selector of each of the dither toggle pattern generators outputs an output of the pseudorandom code generator when the m dot count signal by the dot counter is not outputted, and outputs an output of the m-bit register when the m dot count signal by the dot counter is outputted to the dither synthesis unit as a dither toggle pattern, and
a result obtained by a dither synthesis using the output from the selector inputted into the dither synthesis unit is outputted to the error diffusion processor.
